(19) United States
(12) Patent Application Publication
(10) Pub. No.: US 2009/0265644 A1
(43) Pub. Date: Oct. 22, 2009

(54) Automatic Repositioning of Widgets on Touch Screen User Interface

(76) Inventors: Brandon David Tweed, North Aurora, IL (US); Jason Chester Gareowski, Raleigh, NC (US); Steven Brent Koonce, Durham, NC (US)

Correspondence Address: Steven E. Bach Attorney at Law, 10 Roberts Road, Newtown Square, PA, 19073, US

(21) Appl. No.: 12/104,221

(22) Filed: Apr. 16, 2008

(51) Int. Cl. G06F 3/048

(52) U.S. Cl. 715/762

(57) ABSTRACT

A method, apparatus and program product are provided for repositioning user interface widgets on a touch screen. A repositioning rule is provided. A triggering event is detected. In response to the triggering event, one or more widgets are repositioned in the touch screen interface using the repositioning rule.

### FIELD OF THE INVENTION

The invention relates to the field of touch screen user interfaces and more particularly to a method, apparatus and program product for automatically repositioning widgets on a touch screen interface.

### BACKGROUND

Touch screen interfaces are increasingly present within retail, security, and other environments. Credit and debit card transactions, self-checkouts, electronic airline check-in kiosks, and many other applications commonly utilize touch screen interfaces. These touch screen interfaces typically comprise a plurality of widgets providing various interface elements, including but not limited to dialog boxes where a user may input or receive text messages, labels where a text label is displayed, pads where a user may input an image such as a signature, buttons where a user may indicate a choice such as accept or yes by touching the area of the screen where the button appears, and groups comprising more than one individual widget where a user may indicate a choice such as yes or no.

In situations where a high volume of transactions may be handled by a single touch screen device each day, it is common that wear and tear is localized to the user interface elements that are most frequently touched. Often, these user interfaces are fixed, and the touching, and therefore the wear due to regular touching, is localized to the same areas of a user interface screen, typically one or more button widgets where a user touches a screen to indicate a choice or selection.

Previous attempts to address wear on touch screen interfaces have focused on stronger or more resilient surface materials. Material solutions are expensive due to the cost of the materials and the cost of replacing equipment. Moreover, material solutions apply to the entire screen and do not directly address the issue of localized wear and tear due to repeated touching in the same areas.

### SUMMARY

A method, an apparatus and a program product are provided for repositioning user interface widgets on a touch screen. Code is created to provide a touch-screen user interface when executed. A repositioning rule is provided either as part of the initial touch-screen interface creation, or at a subsequent time. During execution of the code, a triggering event is detected. In response to the triggering event, one or more widgets are repositioned in the touch screen interface using the repositioning rule. The triggering event may be any event that is indicative of wear on a specific area of the touch-screen display corresponding to a particular button widget or group of button widgets. For example, the triggering event may be a period of time based on a clock. Alternatively, the triggering event may be a number of touches for the display or for a particular button widget.

The widgets are repositioned according to one or more repositioning rules. These rules may include one or more of switching locations of two or more widgets, randomly repositioning one or more widgets or other repositioning rules, such as toggling between pre-defined locations, or a repositioning one or more widgets by a pre-defined offset.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a touch screen interface system for automatically repositioning widgets thereon according to an exemplary embodiment of the present invention;

FIG. 2 is a schematic of a touch screen interface according to an exemplary embodiment of the present invention showing a first arrangement of widgets;

FIG. 3 is a schematic of the touch screen interface of FIG. 2 showing a second arrangement of the widgets after an exemplary repositioning;

FIG. 4 is a schematic of the touch screen interface of FIG. 2 showing a third arrangement of the widgets after another exemplary repositioning;

FIG. 5 is a schematic of another touch screen interface according another exemplary embodiment of the present invention showing an initial arrangement of widgets;

FIG. 6 is a schematic of the touch screen interface of FIG. 5 showing a new arrangement of the widgets after an exemplary repositioning according to an exemplary embodiment of the present invention;

FIG. 7 is a schematic of the touch screen interface of FIG. 5 showing a new arrangement of the widgets after an exemplary repositioning according to an exemplary embodiment of the present invention; and

FIG. 8 is a flow diagram of a method for automatically repositioning widgets on a touch screen interface according to an exemplary embodiment of the present invention.

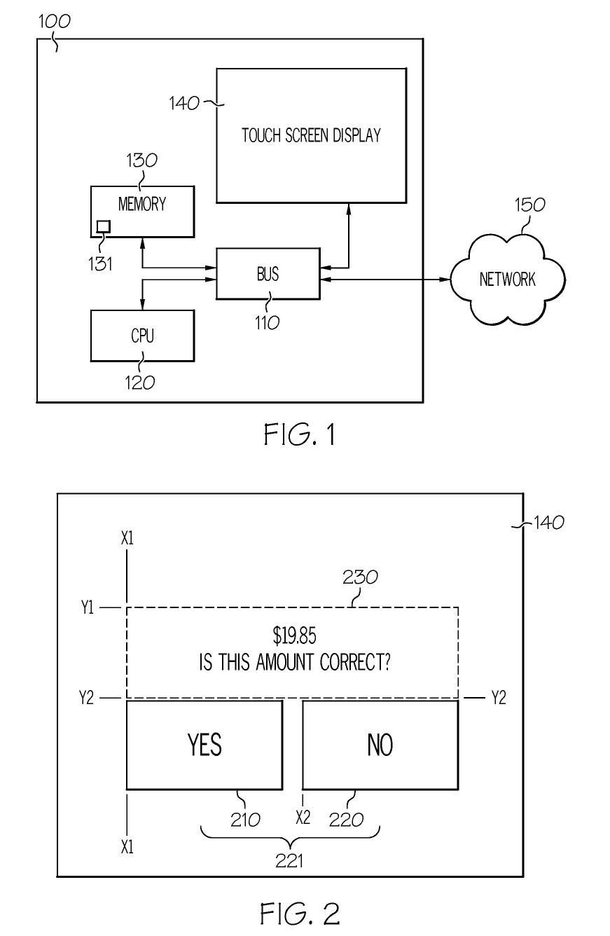

### DETAILED DESCRIPTION

The present invention provides a method, apparatus and program product for automatically repositioning widgets on a touch screen interface. According to an exemplary embodiment an apparatus comprises a data bus 110 interconnected with a processor 120 and a memory 130. A touch screen display 140 is interconnected with the processor 120 through the bus 110. Optionally, the bus 110 may also interconnect with a network 150 for transferring data to and from the processor 120.

A program of instruction 131 is stored on the memory 130 comprising steps, which when executed by the processor 120 cause an interactive touch screen interface to be provided on the touch screen display 140. The processor 120 executing the program of instruction 131 causes the interactive touch screen display 140 to present various widgets 210, 220, 230 (shown in FIG. 2) at predefined areas of the touch screen display 140 identified by a central pixel location. The processor also provides data for display in various widgets and receives push indications from various widgets.

According to an exemplary embodiment, the program of instruction 131 executed by the processor 120 also detects a triggering event, such as the elapsing of a predefined period of time, the detection of a predefined number of touches for a specific pixel location, degraded performance of an area corresponding to a button widget, or any other event that is useful for triggering the repositioning of widgets. In response to detecting a triggering event, the processor 120 executing the program of instruction 131 causes the touch screen display to present a modified touch screen interface on the touch screen display 140. In the modified touch screen interface, one or more widgets are displayed at a different location.

An exemplary touch screen interface is shown in FIG. 2. Pixels are identified by Cartesian coordinate pairs (X,Y) beginning at the upper left corner (1,1) and increasing in the X-coordinate moving to the right and increasing in the Y-coordinate moving down. In this interface, a fixed text widget 230 is located at pixel (X1,Y1) of the touch screen display 140. A group widget 221 comprising two button widgets 210, 220 is located at pixel (X1,Y2), with the button widget 210 indicating a positive response and labeled with the word “YES” located at pixel (X1,Y2), and the button widget 220 indicating a negative response and labeled with the word “NO” located at pixel (X2,Y2).

A user of this exemplary interface 140 is presented with an amount to be charged to a credit card, for example, with the question “Is this amount correct?” in the fixed text widget 230. The user touches the area of the touch screen display 140 in the area of one of the button widgets 210, 220 in the group widget 211 corresponding to whether or not the amount is correct. In this example, the amount displayed will usually be correct, and if the button widget group were fixed, then the area corresponding to the YES button widget 210 would receive much more wear than the area corresponding to the NO button widget 220.

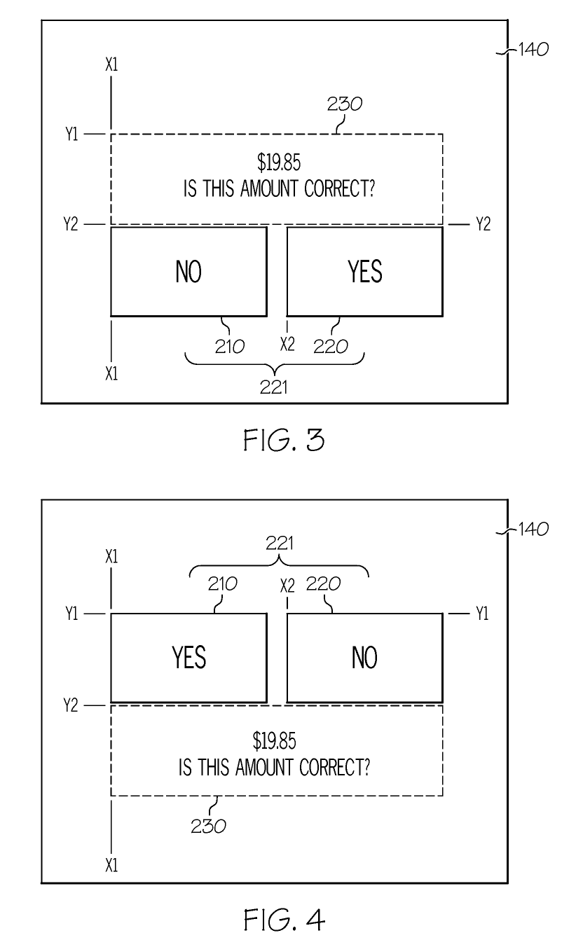

According to an exemplary embodiment, the YES widget 210 and the NO widget 220 are swapped in location within group widget 211. That is, the YES widget 210 is moved from (X1,Y2) as shown in FIG. 2 to (X2,Y2) as shown in FIG. 3, and the NO widget 220 is moved from (X2,Y2) as shown in FIG. 2 to (X1,Y2) as shown in FIG. 3. By swapping the YES and NO widgets 210, 220 within the group widget 211, the wear associated with the YES button widget is distributed over the area (X1,Y2) and the area (X2,Y2). Thus, the wear is balanced across each area.

The YES and NO button widgets 210, 220 may be swapped in location, for example, by exchanging values for the coordinates stored in memory, a file, or database so that the widgets are written in a new location.

The YES and NO widgets 210, 220 may be moved in response to any of a variety of triggering events. For example, the widgets 210, 220 may be swapped at a predefined time interval, such as every hour. Alternatively, the triggering event may be a predefined number of touches, such as after 500 touches of widget 210.

According to another exemplary embodiment, the widget group 211 comprising the YES widget 210 and the NO widget 220 is swapped with the text widget 230. That is, text widget 230 is moved from a pixel location of (X1,Y1) as shown in FIG. 2 to a pixel location of (X1,Y2) as shown in FIG. 4, and the group widget 211 comprising button widgets 210 220 is moved from pixel location (X1,Y2) as shown in FIG. 2 to the pixel location (X1, Y1) as shown in FIG. 4.

The widget group 211 may be swapped with the text widget 230 in response to the triggering events provided above (elapsed time, touch count). Alternatively and/or additionally, the group 211 may be swapped with the text widget 230 in response to a triggering event of degraded button performance in the current area corresponding to the widget group 211.

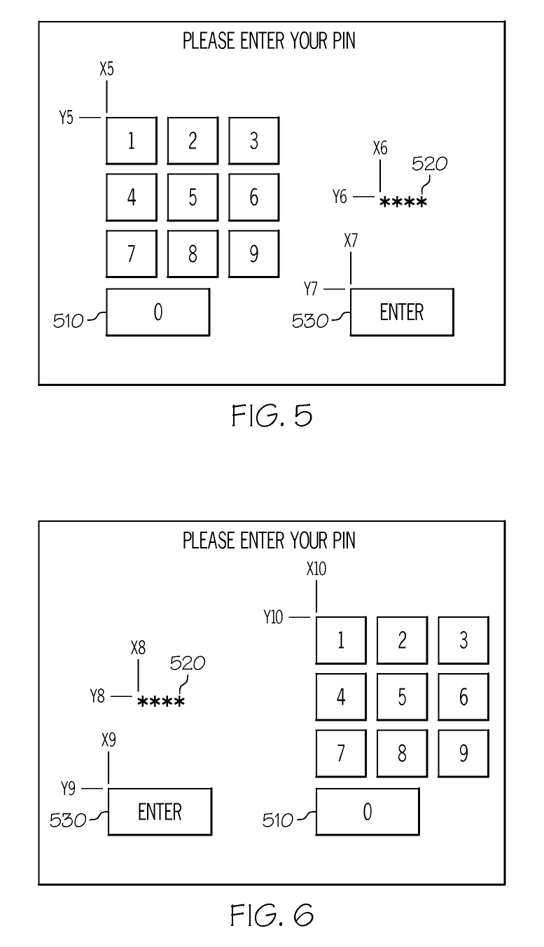

In another exemplary touch screen interface, shown in FIG. 5, a user enters a Personal Identification Number (PIN). The touch screen interface arrangement comprises a widget group 510 comprising a keypad of button widgets for entering the numbers 0 through 9 located at pixel location (X5,Y5) on a touch screen display 140. That is the upper left corner of the group is at the pixel corresponding to (X5,Y5). The touch screen interface arrangement further comprises a dynamic text widget 520 used to display an asterisk for each number entered located at pixel location (X6,Y6). The touch screen interface arrangement further comprises a button widget 530 labeled “Enter” at pixel location (X7,Y7).

A user enters a PIN on the touch screen interface of FIG. 5 by touching the button widgets of the keypad widget group 510 in order corresponding to the user's PIN. As each number is added, another asterisk is presented in dynamic text widget 520 to guide the user in entering his/her PIN. Upon completing the PIN, the user touches the Enter button widget 530 to enter the PIN to a processor.

According to an exemplary embodiment, the keypad widget group 510 is shifted to the right from a pixel location of (X5,Y5) as shown in FIG. 5 to a pixel location of (X10,Y10) as shown in FIG. 6. In this exemplary embodiment, a repositioning is triggered by detection of any of the previously described triggering events, such as elapsed time, touch count, degraded performance, or any other event indicative of use or wear. The repositioning is controlled by repositioning rules, which may comprise, for example, reposition keypad widget group after 500 touches.

The repositioning rules may comprise swapping keypad widget group 510 with dynamic text widget 520 and the Enter button widget 530. Alternatively, the repositioning rules may comprise rules governing the direction(s) and distance(s) of repositioning movement for keypad widget group 510, such as iteratively offsetting the keypad widget group 510 to the next one of a plurality of pre-defined positions or randomly reposition the keypad widget group 510, or any other random or predefined offset such as within the left half of touch screen display 140. The repositioning rule may also take into account the size of the keypad widget group 510 and the distance from a possible pixel location to edges of the display 140 and other widgets to prevent the widget group being repositioned from extending beyond the screen or overlapping another widget.

In an exemplary embodiment, the repositioning rules may comprise repositioning other widgets to accommodate a potential repositioning of the keypad widget group 510. For example, repositioning the keypad widget group 510 from (X5,Y5) to (X6,Y6) would cause it to interfere with dynamic text widget 520 and the Enter button widget 530 if they remained fixed. Accordingly a repositioning rule could cause repositioning of these widgets as well.

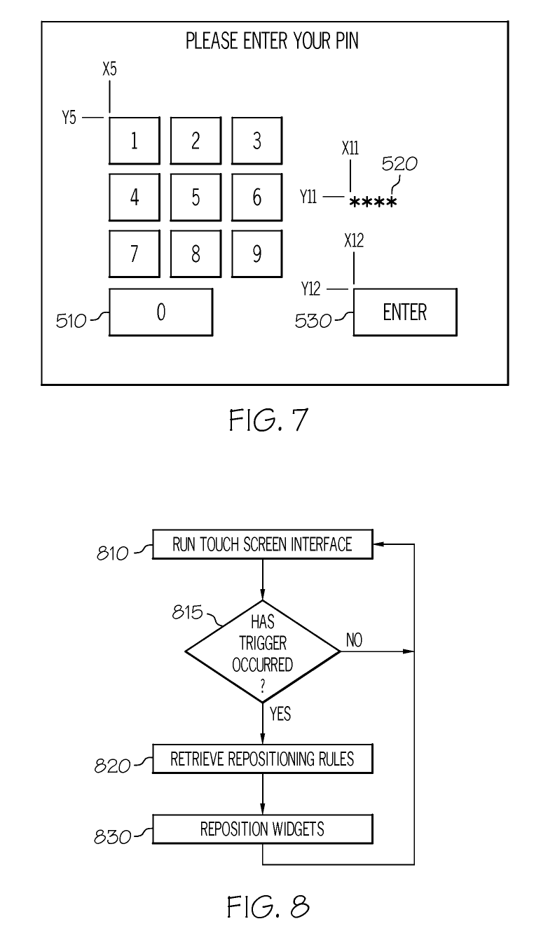

As shown in FIG. 7 one or more widgets may be repositioned independently of other widgets. In this exemplary embodiment, the Enter button widget 530 is repositioned by an offset in both the X and the Y directions from a pixel location of (X7,Y7) as shown in FIG. 5 to a location of (X12,Y12) as shown in FIG. 7. Alternatively, the repositioning could be by an offset limited to either direction alone.

A method for automatically repositioning widgets on a touch screen interface according to an exemplary embodiment of the present invention is shown in FIG. 8. The processor 120 executes the program of instruction 131 to present a touch screen interface on the touch screen display 140 (step 810). In this step various widgets are drawn on the display 140 in an arrangement that includes one or more button widgets or other widgets for receiving a user input.

The program of instruction 131 comprises a test or detection step for determining whether or not a triggering event has occurred (step 815). The triggering event may be, for example, elapsed time, touch count, degraded performance, or the like. In the example of elapsed time, the test step 815 compares a time captured from a clock to a pre-defined threshold to determine whether or not the triggering period of time has elapsed. In the example of a touch count, a counter measures a number of touches. This may be the number of touches for a specific widget, for a group of widgets, for the entire touch screen, for a specific pixel location, or the like. The test step 815 in this embodiment, compares the measured number of touches to a pre-defined triggering threshold. In the exemplary embodiment of degraded performance, one or more performance parameters are monitored, and the test step 815 comprises determining whether or not the performance parameter has reached a pre-defined triggering threshold.

If a triggering event has not occurred, then the program of instruction continues to execute, and the arrangement of widgets on the display screen 140 remains unchanged. If a triggering event is determined to have occurred, then the program of instruction retrieves repositioning rules (step 620), which may be stored in memory 130, for example. The repositioning rules may be any set of rules that control repositioning one or more widgets to provide a new arrangement of widgets, in which at least one widget is repositioned on the touch screen display 140 to another area. By repositioning one or more widgets wear due to touching the touch screen display is distributed to more than one area.

According to an exemplary embodiment, repositioning rules may comprise pre-defined or random repositioning of one or more widgets. Predefined repositioning may be swapping locations of a button widget or other widget subject to wear with another widget that receives less wear such as a lesser used button widget, a text widget, a lank area of the display 140, or the like. Predefined repositioning may also comprise iterative repositioning between a discrete quantity of predefined locations.

Repositioning rules may also comprise fit checks to determine that a widget to be repositioned will fit on the display 140 and that it will not overlap any other widget or an area previously determined to have degraded performance, as well as any other unacceptable repositioning condition.

Following is an exemplary set of repositioning rules. Repositioning rules are specified per widget. The actions of relocation and collision/conflict resolution are performed by the repositioning method. The logic for handling the acts of swapping, incremental relocation, or random relocation for each widget is handled within the repositioning method.

According to an exemplary method, a widget's rule is set at the time that the initial user interface is build. Exemplary microcode for setting the widget's rule is as follows:

| | |
|---|---|
| Button b = new button ( ) | 1 |
| int x = 32 | 2 |
| int y = 23 | 3 |
| b.setPosition(new Point(x,y)); | 4 |
| b.setRule(new SwappingRule( )) | 5 |

In this example, a button b is defined. The button form would be defined in the empty brackets of line 1. The button is initially set at pixel (32,23). A swapping rule is set by specifying a particular swapping rule in the brackets of line 5. This could, for example, be swapping rule 1, swapping rule a, or any other designation.

In this example, a repositioning method comprises logic that checks what rule is set for each widget at the same level. For example, the repositioning method could use the following exemplary microcode:

| | |
|---|---|
| If(b.hasSwappingRule( )){ | 6 |
| SwappingRuleWidgetList.add(b); | 7 |
| }; | 8 |

The swappingRuleWidgetList is a list of the widgets at the same level that have the particular swapping rule set. This list is provided as input to a repositioning pseudo code for swapping the widgets. An exemplary repositioning pseudo code is as follows:

| | |
|---|---|
| set current_level = 1; | 9 |
| boolean done = false; | 10 |
| while(not done) | 11 |
| Gather list of all widgets at current_level | 12 |
| for each repositioning rule | 13 |
| create the list of widgets that adhere to the rule | 14 |
| reposition the widgets according to the rule using the | 15 |
| corresponding logic | |
| end for | 16 |
| if there are any group widgets within the current level | 17 |
| increment current_level; | 18 |
| else | 19 |
| done = true; | 20 |
| end if | 21 |
| end while | 22 |
| create a list of widget collisions (pairs of widgets that overlap) | 23 |
| for each collision | 24 |
| attempt to resolve the collision | 25 |
| end for | 26 |

As can be seen in this exemplary embodiment, a list of widgets adhering to each repositioning rule is created and the widgets in that list are repositioned according to corresponding repositioning logic.

An exemplary repositioning logic for swapping widget locations is as follows:

| | |
|---|---|
| Current_position = get the position of the widget at the end of the list | 27 |
| for each widget in the list | 28 |
| temp_position = current_widget.getposition( ); | 29 |
| current_widget.setPosition(current_position); | 30 |
| current_position = temp_position | 31 |
| end for | 32 |

Thus, the first widget in the list is repositioned to the location of the last widget in the list, and each subsequent widget is repositioned to the position of the previous widget.

An exemplary random repositioning logic for randomly repositioning widgets is as follows:

| | |
|---|---|
| For each widget in the list | 33 |
| Point p = new point( ); | 34 |
| p.x = generate random integer with bounds check | 35 |
| p.y = generate random integer with bounds check | 36 |
| current_widget.setPosition(p); | 37 |
| end for | 38 |

Thus, in this exemplary embodiment, the random repositioning logic repositions each widget having the random repositioning rule to a new location in which the x and y coordinates are randomly generated integers subject to a bounds check.

it should be understood that the foregoing examples are illustrative and not limiting of the invention. Other repositioning rules could also be used within the scope of the invention, such as fixed offset repositioning. Also, in some touch-screen interfaces methods other than absolute positioning are used to locate widgets, such as layout managers, for example. Repositioning rules may be applied to these methods to reposition widgets in response to a triggering event within the scope of this invention.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, performs the steps of the method. This program product may be stored on any of a variety of known machine-readable media, including but not limited to compact discs, floppy discs, USB memory devices, and the like. Moreover, the program product may be in the form of a machine readable transmission such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for repositioning user interface widgets on a touch screen comprising the steps of:
detecting a triggering event; and
in response to said triggering event, repositioning one or more widgets in the touch screen interface.

2. The method of claim 1, wherein said triggering event is a predefined period of time.

3. The method of claim 1, wherein said triggering event is a predefined number of touches of the touch screen.

4. The method of claim 1 wherein the triggering event is degraded performance of one or more screen areas corresponding to a widget.

5. The method of claim 1, wherein the repositioning step comprises shifting at least one of horizontal and vertical screen coordinates of one or more widgets by a predetermined offset.

6. The method claim 1, wherein the repositioning step comprises exchanging the screen coordinates for at least two widgets.

7. The method claim 1, wherein the repositioning step comprises relocating widgets in accordance with constraints and behaviors specified by a relocation rule.

8. The method of claim 6 wherein at least one widget comprising a push button exchanges screen coordinates with a widget that does not comprise a push button.

9. An apparatus for repositioning user interface widgets on a touch screen interface, comprising:
a touch screen display;
a processor interconnected with said display;
a memory interconnected with said processor; and
a program of instruction stored on said memory and executable by said processor;
wherein when said program of instructions is executed by said processor, widgets are displayed on said display, said processor tests to detect a triggering event, and in response to said triggering event, said processor executing said program of instruction repositions said widgets.

10. The apparatus of claim 9, further comprising repositioning rules stored on said memory, whereby said processor executing said program of instruction repositions said widgets according to said repositioning rules.

11. A program product comprising a computer readable media having stored thereon computer executable instructions comprising:
first instructions for detecting a triggering event; and
second instructions for, repositioning one or more widgets in the touch screen interface in response to said triggering event.

12. The program product of claim 11, wherein said triggering event is a predefined period of time.

13. The program product of claim 11, wherein said triggering event is a predefined number of touches of the touch screen.

14. The program product of claim 11 wherein the triggering event is degraded performance of one or more areas corresponding to a widget.

15. The program product of claim 11, wherein the repositioning instructions comprise shifting at least one of horizontal and vertical screen coordinates of one or more widgets by a predetermined offset.

16. The program product of claim 11, wherein the repositioning instructions comprise exchanging the screen coordinates for at least two widgets.

17. The program product of claim 16 wherein at least one widget comprising a push button exchanges screen coordinates with a widget that does not comprise a push button.

18. The program product of claim 11 wherein the repositioning instructions comprise a repositioning rule specifying constraints and behaviors for repositioning one or more widgets.
